(19) United States
(12) Patent Application Publication
(10) Pub. No.: US 2015/0373298 A1
(43) Pub. Date: Dec. 24, 2015

(54) VEHICLE RECORDER-MONITOR SYSTEM

(71) Applicants: IVS, INC., WEST NEWTON, AL (US); DIGIWELL TECHNOLOGY INC., HSINCHU (TW); GEORGE TANG INDUSTRIAL CORP., MIAOLI (TW)

(72) Inventors: RICHIE HOWARD, NEWTON, AL (US); ANTHONY HSIEH, HSINCHU (TW); GEORGE TANG, MIAOLI (TW)

(21) Appl. No.: 14/308,857

(22) Filed: Jun. 19, 2014

(51) Int. Cl. H04N 5/77; H04N 7/18; G06F 17/30

(52) U.S. Cl. CPC H04N 5/77; G06F 17/30781; H04N 7/183; G06F 17/30858

(57) ABSTRACT

A vehicle recorder-monitor system comprises a label control device providing recording modes each corresponding to a file code, clicked on by a user to determine a recording mode, and providing a recording mode signal; an image processing device connected with the label control device, receiving the recording mode signal, recording a file according to the recording mode signal, categorizing and storing the file in a file code corresponding to the recording mode, and sending out the categorized file; and a terminal control device linked to the image processing device, receiving the categorized file and transmitting the categorized file to a server for storage. The system can store the file recorded by the vehicle recorder according to the categorization and transmit the file to the terminal control device instantly, whereby the related personnel can search for and view the files in realtime.

### BACKGROUND OF THE INVENTION

1. Field of the Invention

The present invention relates to a vehicle recorder-monitor system, particularly to a vehicle recorder-monitor system, wherein the user can select a recording mode before video recording and can store the video file in one of the categorized folders for conveniencing the related personnel to search for and view the desired video file.

2. Background of the Invention

Due advancement in technologies and instruments, video recorders can be installed in a vehicle to capture images surrounding the vehicle. Further, the captured images can be transmitted to and stored in a computer via wireless communication. Vehicle recorders not only can promote the safety of the driver but also can provide evidence to solve the disputation in a traffic stop.

Some drivers spend longer time in driving vehicles for their professions, such as the drivers of squad cars, taxies, ambulances and buses, and thus have higher risk of traffic accidents. The current vehicle recorders can indeed provide the video records of surrounding images for drivers to avoid unnecessary traffic disputations. However, the conventional technology cannot provide categorized folders for various video files before they are recorded, causing inconvenience in filing and searching for the video records. If the driver intends to view a video record, he must spend much time in searching for the desired segment from the entire video record. Then, the driver retrieves the video file from the vehicle recorder and displays it in another device. Alternatively, the driver displays the video record in the built-in display device of the vehicle recorder. Once the display device of the vehicle recorder is damaged, the driver would be unable to search for, retrieve and store the desired segment instantly and may lose the critical video record.

Accordingly, the present invention proposes a vehicle recorder-monitor system to overcome the abovementioned problems and convenience the driver to file and search for the video record.

### SUMMARY OF THE INVENTION

The primary objective of the present invention is to provide a vehicle recorder-monitor system, which can automatically provide categorized folders before video recording to reduce the time the related personnel spend in searching for the desired video file, and which can instantly transmit the recorded images to a far-end computer, whereby the driver can store the critical video segment in a designated folder easily, and whereby the related personnel fast find and view the desired video record with a personal computer or via the Internet.

Another objective of the present invention is to provide a vehicle recorder-monitor system, wherein the driver can use a file code to select one of the categorized folders before video recording and store the video record in the selected folder, whereby the system can save the driver and users the time spent in filing or searching for a video record.

To achieve the abovementioned objectives, the present invention provides a vehicle recorder-monitor system, which comprises a label control device; an image processing device electrically connected with the label control device; a signal transceiving device electrically with the image processing device; and a terminal control device linked to the signal transceiving device in a wired or wireless way. The label control device provides a plurality of recording modes respectively corresponding to a plurality of categorized folders. The driver clicks on the label control device during video recording to determine a recording mode and the corresponding folder, and the label control device provides a signal of the recording mode for the image processing device. After receiving the recording mode signal, the image processing device records images according to the recording mode signal, and stores the video file of the recorded images as a categorized file in the folder corresponding to the recording mode, and sends out the categorized file to the signal transceiving device. The signal transceiving device transmits the categorized file to the terminal control device instantly. The terminal control device stores the files according to the categorization. The related personnel can use the terminal control device or another device to search for and view the files conveniently in realtime. Alternatively, the driver can detach the file storage device (a hard drive or an SD memory card) from the image processing device after he has parked vehicle, and then uses a data reading device to retrieve the categorized files of the image processing device and store the files in the terminal control device.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a block diagram schematically showing a vehicle recorder-monitor system transmitting signals to a terminal control device in a wireless way according to one embodiment of the present invention;

FIG. 2 is a block diagram schematically showing a vehicle recorder-monitor system transmitting signals to a terminal control device in a wired way according to one embodiment of the present invention;

FIG. 3 is a diagram schematically showing a hard drive reading device of a vehicle recorder-monitor system according to one embodiment of the present invention;

FIG. 4 is a diagram schematically showing a label control device of a vehicle recorder-monitor system according to one embodiment of the present invention; and

FIG. 5 is a diagram schematically showing file transmission of a vehicle recorder-monitor system according to one embodiment of the present invention.

### DETAILED DESCRIPTION OF THE INVENTION

The present invention discloses a vehicle recorder-monitor system, which provides different recording modes for a vehicle recorder. After the driver clicks on the system to determine a recording mode, the system records images and stores the video file in a computer device according to the recording mode instantly. The related personnel can use another device to search for and view the video file in realtime.

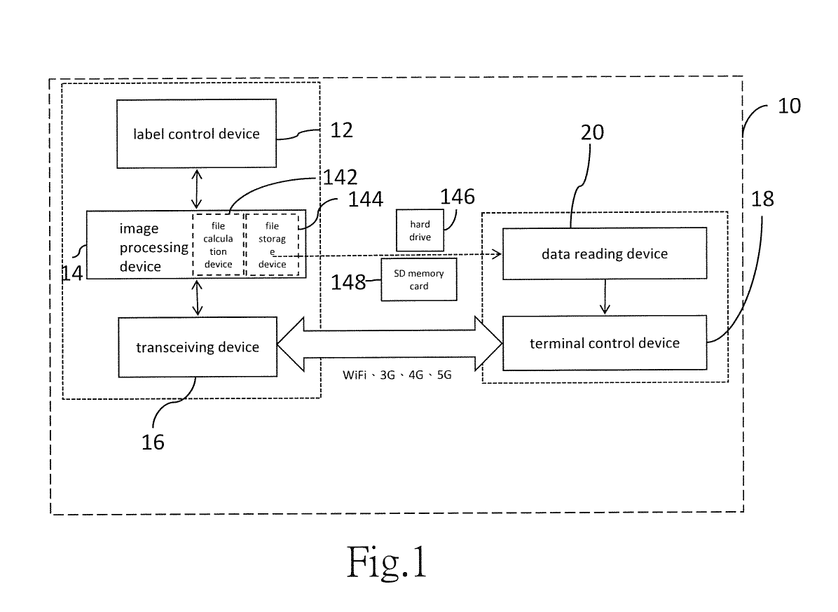

Refer to FIG. 1 for a vehicle recorder-monitor system according to one embodiment of the present invention. The vehicle recorder-monitor system 10 of the present invention comprises a label control device 12; an image processing device 14 electrically connected with the label control device 12; a signal transceiving device 16 electrically with the image processing device 14; and a terminal control device 18 linked to the signal transceiving device 16. In some embodiments, the image processing device 14 is wirelessly linked to the terminal control device 18 via the signal transceiving device 16 for signal transmission. In some embodiments, the signal transceiving device 16 is realized with the WiFi, 3G, 4G, or 5G communication technology of handheld devices. The image processing device 14 includes a file calculation device 142 and a file storage device 144. In some embodiments, the file storage device 144 is a hard drive 146 or an SD (Secure Digital) memory card 148. The terminal control device 18 is electrically connected with a data reading device 20. In some embodiments, the data reading device 20 is a hard drive reading device, or an SD memory card reading device, or contains both. Thereby, while the terminal control device 18 intends to retrieve the file, the hard drive 146 or the SD memory card 148, which functions as the file storage device 144, is plugged in the data reading device 20, and the file is transmitted to the terminal control device 18 via the USB (Universal Serial Bus) port. In the present invention, the image processing device 14 is linked to the terminal control device 18 in a wired or wireless way.

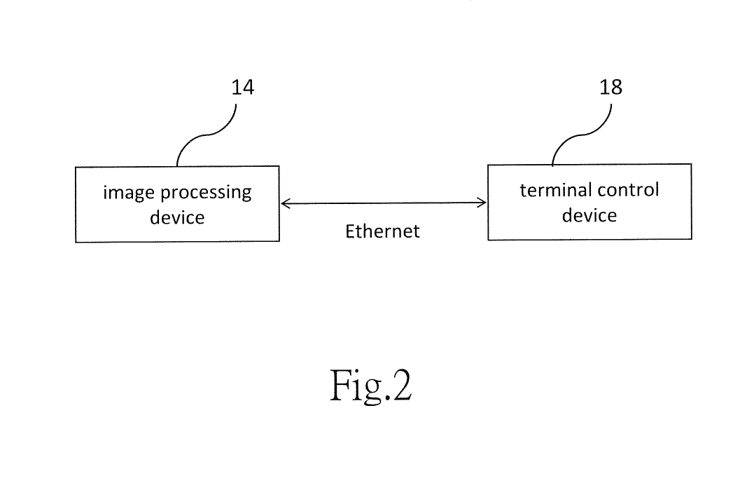

In some embodiments, the transceiving device 16 transmits signals in a wired way, in addition to a wireless way. Refer to FIG. 2 for an example. In FIG. 2, the image processing device 14 is linked to the terminal control device 18 via the Ethernet, whereby the image processing device 14 transmits files to the terminal control device 18 in a wired way.

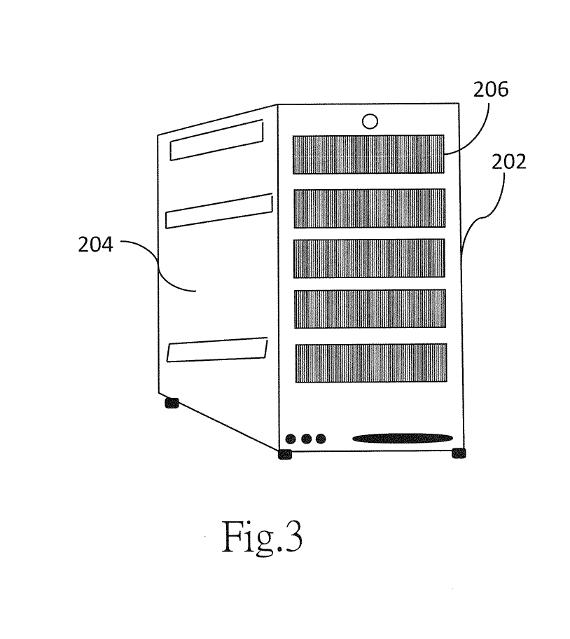

Refer to FIG. 3 and refer to FIG. 1 again. While the data reading device 20 is a hard drive reading device 202, the outmost layer of the hard drive reading device 202 is a housing 204, which protects the internal electronic elements of the hard drive reading device 202. A plurality of hard drive bays 206 is formed inside the housing 204 to accommodate the hard drives 146. The hard drive bays 206 are connected with the terminal control device 18 through USB, whereby the terminal control device 18 can retrieve the data inside the hard drives 146. For example, the driver detaches the hard drive 146 inside the image processing device 14 and installs the hard drive 146 in the hard drive bay 206 of the hard drive reading device 202; the hard drive bay 206 is connected with a computer system or a terminal, which can retrieve the data of the hard drive 146.

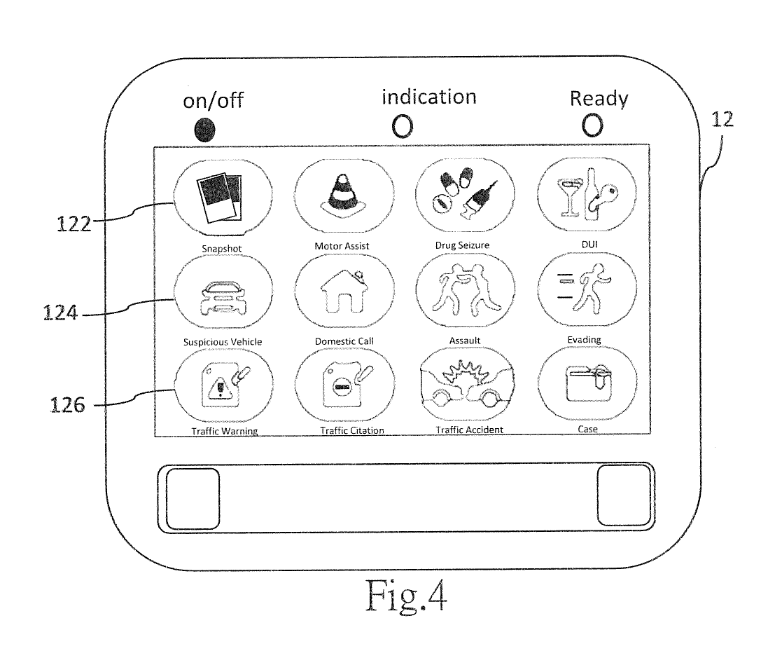

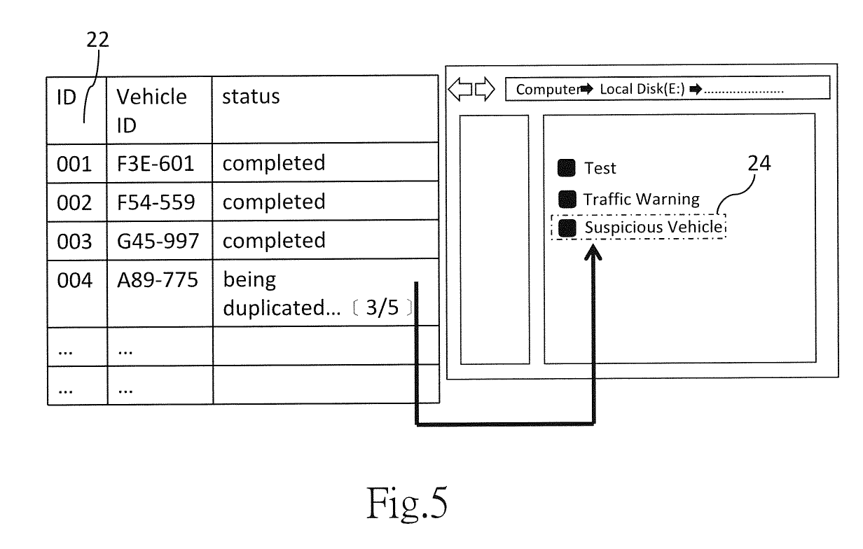

The vehicle recorder-monitor system of the present invention has been described above. The operation of the system of the present invention will be described below. The present invention can be applied to various fields, especially to the vehicles of police and medicine where the present invention would have outstanding efficacy. Refer to FIG. 1, FIG. 4 and FIG. 5. In some embodiments, the label control device 12 is a touchscreen having a plurality of recording modes to be clicked on by the driver, such as a “snapshot” button 122, a “traffic warning” button 124, a “suspicious vehicle” button 126, etc. The policeman can monitor the suspicious vehicles on the road via clicking on the “suspicious vehicle” button 126. The symbol of the selected mode will be presented on the pictures of the video records, whereby the viewers can learn the recording mode of the video record. There is a plurality of file codes 22 each corresponding to a recording mode. The file code 22 is a combination of numerals, letters or both. The fields behind a file code 22 record the vehicle ID and_the video recording status of the file having the file code 22. After a recording mode has been selected, the signal of the selected recording mode is transmitted to the image processing device 14. Then, the built-in lens is controlled to execute the selected recording mode and record images. The file calculation device 142 of the image processing device 14 files the video records as video files categorized according to the file codes 22, and the file storage device 144 stores the video files in the corresponding folders. If the video file of a vehicle ID “A89-775” has a file code 22 “004”, it means that the driver clicked on the “suspicious vehicle” button 126 for the vehicle having a vehicle ID “A89-775”. Thus, the vehicle recorder-monitor system 10 of the present invention instantly transmits the video file recorded in the “suspicious vehicle” mode to a “suspicious vehicle” folder 24 in the terminal control device 18 for backup and storage. Thereby, the related personnel, who are not in the vehicle, can directly view the recorded video file from the terminal control device 18 or retrieve the video files that have been categorized and stored in the corresponding folders. In some embodiments, the terminal control device 18 is a computer. However, the present invention does not limit that the terminal control device 18 must be a computer.

In addition to using the vehicle recorder-monitor system 10 of the present invention to instantly transmit a video file, the driver can also detach the file storage device 144 from the image processing device 14 after the vehicle has been parked. The file storage device 144 (the hard drive 146 or the SD memory card 148) is inserted into the data reading device 20 (a hard drive reading device or an SD memory card reading device). The data reading device 20 retrieves the video file, which has been categorized according to the recoding mode, from the file storage device 144, and transmits the video file to the terminal control device 18 via USB. Thereby, the present invention can save the driver the time of building files and assist the driver to categorize and administrate the files efficiently.

Then, the terminal control device 18 receives the video files, which have been categorized according to their recording modes, in a wired way, a wireless way, or via the data reading device 20. In some embodiments, the terminal control device 18 transmits the video files to a server for storage. In some embodiments, the server further transmits the video files to the cloud as the backup copies. The present invention allows the related personnel to view the video files instantly according to the categorization thereof. For example, the field-service policemen can use the vehicle recorder-monitor system 10 of the present invention to instantly view or backup the video files; the policemen not attending the corresponding field service can search for the video files according to the file codes in the police office. Therefore, the present invention can automatically administrate the video files of driving records. Once the suspicious vehicle is found to have criminal history, the present invention can provide related information to the other policemen in field service in realtime to execute appropriate action instantly.

The embodiments described above are to demonstrate the technical thought and characteristics of the present invention to enable the persons skilled in the art to understand, make, and use the present invention. However, these embodiments are not intended to limit the scope of the present invention. Any equivalent modification or variation according to the spirit of the present invention is to be also included within the scope of the present invention.

What is claimed is:

1. A vehicle recorder-monitor system comprising
a label control device providing a plurality of recording modes each corresponding to a file code, clicked on by a user to determine a recording mode, and providing a signal of said recording mode;
an image processing device connected with said label control device, receiving said signal of said recording mode, recording a video file according to said signal of said recording mode, and storing said video file with one said file code corresponding to said recording mode; and
a terminal control device connected with said image processing device, and receiving said video file recorded in said recording mode and said file code via signal transmission.

2. The vehicle recorder-monitor system according to claim 1, wherein said image processing device further comprises
at least one lens for capturing images;
a file calculation device recognizing said file code; and
a file storage device storing said file code recognized by said file calculation device and said video file recorded in said recording mode corresponding to said file code.

3. The vehicle recorder-monitor system according to claim 2, wherein said file storage device is a hard drive or an SD (Secure Digital) memory card.

4. The vehicle recorder-monitor system according to claim 1, wherein said label control device is a touchscreen.

5. The vehicle recorder-monitor system according to claim 1, wherein said file code is a combination of numerals, letters, or both.

6. The vehicle recorder-monitor system according to claim 1, wherein said terminal control device is linked to said image processing device in a wired way or a wireless way.

7. The vehicle recorder-monitor system according to claim 6 further comprising a signal transceiving device, wherein said image processing device is connected with said signal transceiving device and then linked to said terminal control device through said signal transceiving device.

8. The vehicle recorder-monitor system according to claim 7, wherein said signal transceiving device transceives signals in a WiFi (Wireless Fidelity) technology.

9. The vehicle recorder-monitor system according to claim 7, wherein said signal transceiving device transceives signals in a 3G, 4G, or 5G communication technology of handheld devices.

10. The vehicle recorder-monitor system according to claim 6, wherein said terminal control device is linked to said image processing device through an Ethernet.

11. The vehicle recorder-monitor system according to claim 3 further comprising a data reading device connected with said terminal control device and said image processing device, reading files from said image processing device, and transmitting said files to said terminal control device.

12. The vehicle recorder-monitor system according to claim 11, wherein said data reading device is a hard drive reading device able to read data in a hard drive.

13. The vehicle recorder-monitor system according to claim 12, wherein said hard drive reading device further comprises
a housing; and
a plurality of hard drive bays arranged inside said housing and accommodating said hard drive.

14. The vehicle recorder-monitor system according to claim 12, wherein said file storage device is a hard drive, and said hard drive is installed in said hard drive reading device.

15. The vehicle recorder-monitor system according to claim 11, wherein said data reading device is an SD memory card reading device including at least one SD memory card slot where at least one SD memory card is installed.

16. The vehicle recorder-monitor system according to claim 15, wherein said file storage device is an SD memory card, and said SD memory card is installed in said SD memory card reading device.

17. The vehicle recorder-monitor system according to claim 11, wherein said data reading device transmits files to said terminal control device through USB (Universal Serial Bus).

18. The vehicle recorder-monitor system according to claim 1 further comprising a server connected with said terminal control device and storing said file code and said video file recorded according to a recording mode corresponding to said file code.

19. The vehicle recorder-monitor system according to claim 1, wherein said terminal control device is a computer.
